(19) United States
(12) Patent Application Publication
(10) Pub. No.: US 2020/0081444 A1
(43) Pub. Date: Mar. 12, 2020

(54) CLEANING METHOD CAPABLE OF AUTOMATICALLY PLANNING PATH

(71) Applicants: Hong HUANG, Hangzhou City (CN); Yikun TAO, Hangzhou City, (CN); Jie LIU, Hangzhou City, (CN); Lvjun JIN, Hangzhou City (CN)

(72) Inventors: Hong HUANG, Hangzhou City (CN); Yikun TAO, Hangzhou City, (CN); Jie LIU, Hangzhou City, (CN); Lvjun JIN, Hangzhou City (CN)

(21) Appl. No.: 15/745,630

(22) PCT Filed: Jan. 12, 2018
(86) PCT No.: PCT/CN2018/072484

§ 371 Date: Mar. 5, 2018

(51) Int. Cl. G05D 1/02; A47L 11/28; A47L 11/40

(52) U.S. Cl. CPC G05D 1/0219; G05D 1/0231; G05D 2201/0203; A47L 11/4011; A47L 11/4066; A47L 11/28

(57) ABSTRACT

The present invention relates to a cleaning method capable of automatically planning a path. The method comprises the following steps: obtaining a 3D laser point cloud map of a site to be cleaned and performing data processing on point clouds to obtain a ground plane equation of all point clouds; using the generated ground plane equation of the point clouds and point cloud data to determine a cleanable region; performing grid division on the obtained cleanable region to divide into sub-regions to be cleaned according to the size of non-connected regions in grid regions; and performing a bow-shaped path planning for each of the sub-regions to be cleaned, and connecting paths planned for each of the sub-regions to obtain a path planning for the entire region to be cleaned. The present invention has advantages that the region to be cleaned in a working environment is determined on the basis of the 3D laser, and a cleaning path is automatically planned without too much human participation, and it thus can efficiently save the user's implementation time, reflecting the extremely high intelligence of the floor scrubbing robot.

### FIELD OF THE INVENTION

The present invention relates to the technical field of floor scrubbing robots, in particular to a cleaning method capable of automatically planning a path.

### DESCRIPTION OF THE PRIOR ART

With the development of robotics, robots have infiltrated all aspects of human life. Compared with industrial robots with a variety of extraordinary applications in industrial production, floor scrubbing robots are one of few robots working around ordinary people. Nowadays, floor scrubbing robots can often be seen in various places such as airports and shopping malls. For a floor scrubbing robot, its cleaning manner is one of the primary concerns for users. The cleaning manner of a floor scrubbing robots not only involves the simplicity in robot deployment, but also relates to whether the floor scrubbing robot can efficiently clean its working regions and can 100% cover every place to be cleaned.

Cleaning manners of existing floor scrubbing robots are as follows: some work in a random covering manner, and this manner implements random cleaning based on collision-type navigation, which does not depend on the map of environment and does not perform global positioning navigation; some work under human instructions, and people have to define a cleaning region and give instructions to plan a cleaning trace; and some work in a demonstrating type cleaning manner, that is, a person cleans the floor first and the robot records the path of manual cleaning and then follows the trajectory of human cleaning to clean the floor.

The cleaning manners of the above-described existing floor scrubbing robots have the following disadvantages:

1. the random covering type cleaning manner cannot intelligently plan a cleaning region due to the lack of a map of the entire environment, and it is difficult to completely cover the cleaning region in time by random cleaning;

2. the cleaning manner under human instructions needs human participation, leading to an increase of implementation costs of robots; and

3. the cleaning effect of the demonstrating type cleaning manner depends on the quality of human demonstration, and the human demonstration consumes a lot of time for manual implementation.

Therefore, those skilled in the art are devoted to developing a more intelligent cleaning method for floor scrubbing robots, which can intelligently plan a cleaning region without human intervention, saving implementation costs of the robots and improving scrubbing efficiency.

### SUMMARY OF THE INVENTION

In view of the above disadvantages of the prior art, the technical problems to be solved by the present invention are the following: 1. by analyzing a 3D laser map of a scene, a cleaning region is automatically determined without human intervention; 2. by automatically planning a path for the cleaning region, a floor scrubbing robot can realize efficient full coverage of paths in the cleaning region, greatly reducing the implementation cost of the robot; and 3. by dividing the cleaning region, regions can be intelligently selected to be cleaned, which improves the cleaning efficiency.

In order to achieve the above objects, the present invention provides a cleaning method capable of automatically planning a path, comprising the following steps:

Step 1: obtaining a 3D laser point cloud map of a site to be cleaned and performing data processing on point clouds to obtain a ground plane equation of all point clouds;

Step 2: using the generated ground plane equation of the point clouds and point cloud data to determine a cleanable region;

Step 3: performing grid division on the obtained cleanable region to divide into sub-regions to be cleaned according to the size of non-connected regions within grid regions; and

Step 4: performing bow-shaped path planning for each of the sub-regions to be cleaned, and connecting paths planned for each of the sub-regions to obtain a path planning for the entire region to be cleaned.

Further, Step 1 specifically includes the following steps:

Step 1.1: according to a height Hₗₐₛₑᵣ, at which a laser is installed on a floor scrubbing robot, determining differences between the point cloud height coordinates of the ground and the height coordinates of the laser as Hₗₐₛₑᵣ;

Step 1.2: in an event that the floor scrubbing robot moves on the ground of the site to be cleaned when constructing the point cloud map, screening out ground point clouds within a range of 2 meters around paths taken by the robot during the map construction, according to the height coordinate difference Hₗₐₛₑᵣ;

Step 1.3: filtering noise out of the screened ground point clouds;

Step 1.4: performing data fitting on coverage regions of the filtered point clouds to generate a ground plane equation of paths for the map construction; and

Step 1.5: gradually extending and lengthening the generated plane so that the generated plane covers the entire point cloud range, thus obtaining the ground plane equation of all the point cloud.

Further, median filtering is used in Step 1.3 to filter out noise of an abnormal height value.

Further, the data fitting in Step 1.4 is implemented by way of plane fitting.

Further, Step 2 specifically includes the following steps:

Step 2.1: traversing the entire point cloud map by using the generated ground plane equation of the point clouds to screen out all point clouds falling within height differences of ±5 cm of the ground plane equation;

Step 2.2: filtering isolated points out of the screened point clouds to obtain the coverage regions of the point clouds without isolated points; and

Step 2.3: determining a cleanable region according to the coverage regions of the point clouds without isolated points.

Further, the isolated point in Step 2.2 refers to a point having less than five points within a range of half a meter of the point.

Further, Step 3 specifically includes the following steps:

Step 3.1: dividing the cleanable region with 10 m*10 m grids to obtain a series of grid regions;

Step 3.2: from the bottom left corner of the entire map, traversing all the grid regions from left to right and from bottom to top, and when the traversing reaches each of the grid regions, judging all non-connected regions in the grid region to determine cleanable sub-regions; and

Step 3.3: traversing all the cleanable regions to obtain all cleanable sub-regions with an area over 50 m².

Further, judging all the non-connected regions in the grid regions in Step 3.2 to determine cleanable sub-regions is specifically implemented by:

when the area of the non-connected region exceeds 50 m², setting the non-connected region as an independent sub-region to be cleaned; or

when the area of the non-connected region does not exceed 50 m², integrating the non-connected region and a non-connected region having the largest contact area surrounding the former into one sub-region to be cleaned.

Further, Step 4 specifically includes the following steps:

Step 4.1: using lines with an interval of Wᵣ and in parallel with the x-axis to cover the entire sub-region to be cleaned, and then removing lines having a distance less than Wᵣ/2 from the upper and lower boundaries of the sub-region to be cleaned, truncating the remaining parallel lines by points having the distance of Wᵣ/2 from the boundaries of the sub-region to be cleaned, and then performing straight-line connection on end points of line segments included within the sub-region to be cleaned to form a bow shape, thus obtaining a bow-shaped path of the sub-region to be cleaned, where Wᵣ is the width of the floor scrubbing robot, the x-axis direction is rightward and the y-axis direction is upward; and

Step 4.2: planning two trajectories having the distance of Wᵣ/2 from the upper and lower boundaries, and adding them into the bow-shaped path of the sub-region to be cleaned to connect with a previously planned path to obtain a path planning of the sub-region, and then connecting the path of each of the sub-regions to obtain a bow-shaped path fully covering the cleanable region.

The present invention further provides a floor scrubbing robot capable of automatically planning a path, which runs the cleaning method capable of automatically planning a path to complete the cleaning work of a site.

The present invention provides a cleaning method for the floor scrubbing robot that automatically plans a path, which determines a region to be cleaned for a working environment based on a 3D laser and plan a cleaning path automatically. Because the region to be cleaned and path are both automatically planned without human participation, it can greatly save the user's implementation time, reflecting the extremely high intelligence of the floor scrubbing robot. Compared with the prior art, the present invention has the following advantages:

1. by combining the installation height of the laser and the 3D point cloud map, the ground equation of the environment is extracted and the cleanable region is determined automatically;

2. by performing automatic path planning for the cleanable region, full coverage of the cleanable region is achieved without human instructions, and the robot can implement it simply; and

3. by dividing the cleanable region into sub-regions, a sub-region can be intelligently selected to be cleaned and thus the cleaning is flexible and efficient.

The concept, specific structure and technical effects of the present invention will be further described below with reference to the accompanying drawing to fully understand the objects, features and effects of the present invention.

### BRIEF DESCRIPTION OF THE DRAWING

FIG. 1 is a schematic flowchart of a cleaning method capable of automatically planning a path according to a preferred embodiment of the present invention.

### DETAILED DESCRIPTION OF THE PREFERRED EMBODIMENTS

The preferred embodiments of the present invention are described below with reference to the accompanying drawings, so as to make the technical content thereof clearer and easier to understand. The present invention can be embodied in many different forms of embodiments, and the protection scope of the present invention is not limited to only the embodiments mentioned herein.

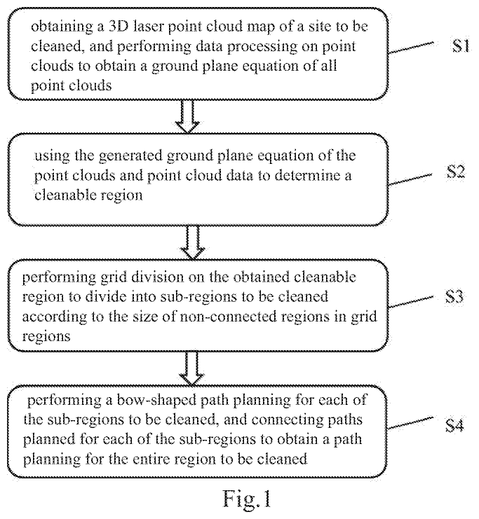

As shown in FIG. 1, a cleaning method capable of automatically planning a path comprises the following main steps:

S1. obtaining a 3D laser point cloud map of a site to be cleaned, and performing data processing on point clouds to obtain a ground plane equation of all point clouds;

S2. using the generated ground plane equation of the point cloud and point cloud data to determine a cleanable region;

S3. performing grid division on the obtained cleanable region to divide into sub-regions to be cleaned according to the size of non-connected regions in grid regions; and

S4. performing bow-shaped path planning for each of the sub-regions to be cleaned, and connecting paths for each of the sub-regions to obtain a path planning for the entire region to be cleaned.

The specific process is as follows:

StepS1: after the 3D laser point cloud map of the site to be cleaned is obtained, the point cloud can be processed to extract point cloud data of the ground.

The height at which a laser is installed on a floor scrubbing robot is known, and indicated by Hₗₐₛₑᵣ. Generally, the ground has smoothness. When the floor scrubbing robot moves on the ground of the site to be cleaned upon constructing the point cloud map, and therefore differences between point cloud height coordinates of the ground and height coordinates of the laser are mostly near Hₗₐₛₑᵣ, and thus point clouds within a range of 2 meters around paths taken by the robot during the map construction can be screened out.

After the point clouds within the range of 2 meters around the paths for the map construction are screened out, noise filtering is carried out on the screened point clouds and median filtering is used to filter out noise of an abnormal height value. After noise is filtered out, plane fitting is carried out on the region covered by the screened point clouds to generate a ground plane equation near the paths for the map construction. Then, the generated plane is gradually extended and lengthened so that the generated plane covers the entire point cloud range, thus obtaining the ground plane equation of all the point clouds.

Step S2: during the construction stage of the environment point cloud map, the ground of all the cleanable regions is scanned into the point cloud map.

The generated ground plane equation of the point clouds is used to traverse the entire point cloud map to screen out all point clouds falling within height differences of ±5 cm of the ground plane equation. Then, isolated points are filtered out of the screened point clouds; an isolated point is determined in a way that all the points are traversed and a point is considered as an isolated point if there are less than five points within a range of half a meter of the point. The region covered by the remaining point clouds is a region having normal ground, thus obtaining a cleanable region.

Step S3: the region to be cleaned by the floor scrubbing robot is generally large, and it is relatively difficult to carry out path planning directly to the entire region; moreover, manual cleaning is carried out by cleaning the sub-regions one by one, and there will be planned selectable regions for operation; generally, the cleaning of each region is scheduled according to a cleaning history record, and a region that is most dirty currently is preferentially cleaned mainly. Therefore, the embodiment of the present invention divides the obtained cleanable region into sub-regions to be cleaned in the following way specifically: first, the cleanable region is divided with 10 m*10 m grids to obtain a series of grid regions. Since the cleanable region is generally irregular, all the grid regions are different in terms of area and shape of the really cleanable region within each grid region and the number of non-connected regions included in each grid region. In order to avoid dividing a too small region into a sub-region to be cleaned or dividing multiple non-connected regions into one sub-region to be cleaned, all the grid regions are traversed from left to right and from bottom to top from the bottom left corner of the entire map. When the traversing reaches one grid region, all non-connected regions within the grid region are judged; if the area of the non-connected regions exceeds a half of 10 m*10 m, then the region is set as an independent sub-region to be cleaned, otherwise the non-connected region is integrated with a region having the largest contact area surrounding the former into a new region. After all the sub-regions are traversed, we obtain all cleanable sub-regions with an area more than 50 m².

Step S4: a bow-shaped path is used to cover each sub-region to be cleaned. The width of the floor scrubbing robot is Wᵣ, the positive direction of x-axis is rightward and the positive direction of y-axis is upward. First, lines with an interval of Wᵣ and in parallel with the x-axis are used to cover the entire sub-region, then lines having a distance less than Wᵣ/2 from the upper and lower boundaries of the region are removed, the remaining parallel lines are truncated by points having the distance Wᵣ/2 from the boundaries of the region, and then straight-line connection are carried out on end points of line segments included within the sub-region to form a bow shape, thus obtaining a path of the sub-region to be cleaned. In order to ensure that the upper and lower boundaries of the sub-region can be cleaned, two trajectories having the distance Wᵣ/2 from the upper and lower boundaries are planned and added to and connected with the previously planned bow-shaped path to obtain a final path planning of the sub-region. The paths of all the sub-regions are connected to obtain a bow-shaped path fully covering the entire region to be cleaned.

The preferred embodiment of the present invention has been described in detail above. It should be understood that numerous variations and modifications can be made by a person of ordinary skill in the art in accordance with the concept of the present invention without inventive skills. Therefore, any technical solution that can be concluded by those skilled in the art through logical analysis, reasoning or limited experiments in accordance with the concept of the present invention on the basis of the prior art shall fall within the protection scope determined by the claims.

1. A cleaning method capable of automatically planning a path, wherein the method comprises the following steps:
Step 1: obtaining a 3D laser point cloud map of a site to be cleaned, and performing data processing on point clouds to obtain a ground plane equation of all point clouds;
Step 2: using the generated ground plane equation of the point clouds and point cloud data to determine a cleanable region;
Step 3: performing grid division on the obtained cleanable region to divide into sub-regions to be cleaned according to the size of non-connected regions in grid regions; and
Step 4: performing bow-shaped path planning for each of the sub-regions to be cleaned, and connecting paths planned for each of the sub-regions to obtain a path planning for the entire region to be cleaned.

2. The cleaning method capable of automatically planning a path according to claim 1, wherein Step 1 specifically comprises the following steps:
Step 1.1; according to a height Hₗₐₛₑᵣ at which a laser is installed on a floor scrubbing robot, determining differences between point cloud height coordinates of the ground and height coordinates of the laser as Hₗₐₛₑᵣ;
Step 1.2: in an event that the floor scrubbing robot moves on the ground of the site to be cleaned when constructing a point cloud map, screening out ground point clouds within a range of 2 meters around paths taken by the robot during the map construction, according to the height coordinate difference Hₗₐₛₑᵣ;
Step 1.3: filtering noise out of the screened ground point clouds;
Step 1.4: performing data titling on coverage regions of the filtered point clouds to generate a ground plane equation of paths for the map construction; and
Step 1.5: gradually extending and lengthening a generated plane so that the generated plane covers the entire point cloud range, thus obtaining the ground plane equation of all the point clouds.

3. The cleaning method capable of automatically planning a path according to claim 2, wherein median filtering is used in Step 1.3 to filter out noise of an abnormal height value.

4. The cleaning method capable of automatically planning a path according to claim 2, wherein the data fitting in Step 1.4 is implemented by way of plane fining.

5. The cleaning method capable of automatically planning a path according to claim 1, wherein Step 2 comprises the following steps:
Step 2.1: traversing the entire point cloud map by using the generated ground plane equation of the point clouds to screen out all point clouds falling within height differences of ±5 cm of the ground plane equation;
Step 2.2: filtering isolated points out of the screened point clouds to obtain coverage regions of the point clouds without isolated points; and
Step 2.3: determining a cleanable region according to the coverage regions of the point clouds without isolated points.

6. The cleaning method capable of automatically planning a path according to claim 5, wherein the isolated point in Step 2.2 refers to a point having less than five points within a range of half a meter of the point.

7. The cleaning method capable of automatically planning a path according to claim 1, wherein Step 3 specifically comprises the following steps:
Step 3.1: dividing the cleanable region with 10 m*10 m grids to obtain a series of grid regions;
Step 3.2: from the bottom left corner of the entire map, traversing all the grid regions from left to right and from bottom to top, and when the traversing reaches each of the grid regions, judging all non-connected regions in the grid region to determine a cleanable sub-region; and
Step 3.3: traversing all the cleanable regions to obtain all cleanable sub-regions with an area over 50 m².

8. The cleaning method capable of automatically planning a path according to claim 7, wherein judging all the non-connected regions in the grid region to determine cleanable sub-regions in Step 3.2 is specifically implemented by;
when the area of the non-connected region exceeds 50 m², setting the non-connected region as an independent sub-region to be cleaned;
when the area of the non-connected region does not exceed 50 m², integrating the non-connected region and a non-connected region with the largest contact area surrounding the non-connected region into one sub-region to be cleaned.

9. The cleaning method capable of automatically planning a path according to claim 1, wherein Step 4 specifically comprises the following steps:
Step 4.1: using lines with an interval of Wᵣ and in parallel with the x-axis to cover the entire sub-region to be cleaned, and then removing lines having a distance less than Wᵣ/2 from upper and lower boundaries of the sub-region to be cleaned, truncating the remaining parallel lines by points having the distance Wᵣ/2 from the boundaries of the sub-region to be cleaned, and then performing straight-line connection on end points of line segments included within the sub-region to be cleaned to form a bow shape, thus obtaining a bow-shaped path of the sub-region to be cleaned, wherein Wᵣ is the width of the floor scrubbing robot, the positive direction of the x-axis is rightward and the positive direction of the y-axis is upward; and
Step 4,2: planning two trajectories having the distance Wᵣ/2 from the upper and lower boundaries, and adding them to the bow-shaped path of the sub-region to be cleaned to connect with a previously planned path to obtain a path planning of the sub-region, and then connecting the paths of each of the sub-regions to obtain a bow-shaped path fully covering the cleanable region.

10. A floor scrubbing robot capable of automatically planning a path, wherein the floor scrubbing robot runs the cleaning method capable of automatically planning a path according to claim 1 to complete the cleaning work of a site.

11. The floor scrubbing robot capable of automatically planning a path according to claim 10, wherein Step 1 specifically comprises the following steps:
Step 1.1: according to a height Hₗₐₛₑᵣ at which a laser is installed on a floor scrubbing robot, determining differences between point cloud height coordinates of the ground and height coordinates of the laser as Hₗₐₛₑᵣ.
Step 1.2: in an event that the floor scrubbing robot moves on the ground of the site to be cleaned when constructing a point cloud map, screening out ground point clouds within a range of 2 meters around paths taken by the robot during the map construction, according to the height coordinate difference Hₗₐₛₑᵣ;
Step 1.3: filtering noise out of the screened ground point clouds;
Step 1.4: performing data fitting on coverage regions of the filtered point clouds to generate a ground plane equation of paths for the map construction; and
Step 1.5: gradually extending and lengthening a generated plane so that the generated plane covers the entire point cloud range, thus obtaining the ground plane equation of all the point clouds.

12. The floor scrubbing robot capable of automatically planning a path accord to claim 11, wherein median filtering is used in Step 1.3 to filter out noise of an abnormal height value.

13. The floor scrubbing robot capable of automatically planning a path according to claim 11, wherein the data fitting in Step 1.4 is implemented by way of plane fitting.

14. The floor scrubbing robot capable of automatically planning a path accord to claim 10, wherein Step 2 comprises the following steps:
Step 2.1: traversing the entire point cloud map by using the generated ground plane equation of the point clouds to screen out all point clouds failing within height differences of ±5 cm of the ground plane equation;
Step 2.2: filtering isolated points out of the screened point clouds to obtain coverage regions of the point clouds without isolated points; and
Step 2.3: determining a cleanable region according to the coverage regions of the point clouds without isolated points.

15. The floor scrubbing robot capable of automatically planning a path according to claim 14, wherein the isolated point in Step 2.2 refers to a point having less than five points within a range of half a meter of the point.

16. The floor scrubbing robot capable of automatically planning a path according to claim 10, wherein Step 3 specifically comprises the following steps:
Step 3.1: dividing the cleanable region with 10 m *10 m grids to obtain a series of grid regions;
Step 3.2: from the bottom left corner of the entire map, traversing all the grid regions from left to right and from bottom to top, and when the traversing reaches each of the grid regions, judging all non-connected regions in the grid region to determine a cleanable sub-region; and
Step 3.3: traversing all the cleanable regions to obtain all cleanable sub-regions with an area over 50 m².

17. The floor scrubbing robot capable of automatically planning a path according to claim 16, wherein judging all the non-connected regions in the grid region to determine cleanable sub-regions in Step 3.2 is specifically implemented by:
when the area of the non-connected region exceeds 50 m², setting the non-connected region as an independent sub-region to be cleaned;
when the area of the non-connected region does not exceed 50 m², integrating the non-connected region and a non-connected region with the largest contact area surrounding the non-connected region into one sub-region to be cleaned.

18. The floor scrubbing robot capable of automatically planning a path according to claim 10, wherein Step 4 specifically comprises the following steps:
Step 4.1: using lines with an interval of Wᵣ and in parallel with the x-axis to cover the entire sub-region to be cleaned, and then removing lines having a distance less than Wᵣ/2 from upper and lower boundaries of the sub-region to be cleaned, truncating the remaining parallel lines by points having the distance Wᵣ/2 from the boundaries of the sub-region to be cleaned, and then performing straight-line connection on end points of line segments included within the sub-region to be cleaned to form a bow shape, thus obtaining a bow-shaped path of the sub-region to be cleaned, wherein Wᵣ is the width of the floor scrubbing robot, the positive direction of the x-axis is rightward and the positive direction of the y-axis is upward; and
Step 4.2: planning two trajectories having the distance Wᵣ/2 from the upper and lower boundaries, and adding them to the bow-shaped path of the sub-region to be cleaned to connect with a previously planned path to obtain a path planning of the sub-region, and then connecting the paths of each of the sub-regions to obtain a bow-shaped path fully covering the cleanable region.
